(19) United States
(12) Patent Application Publication
(10) Pub. No.: US 2026/0267507 A1
(43) Pub. Date: Sep. 10, 2026

(54) MEMORY MANAGEMENT METHOD AND MEMORY CONTROLLER

(71) Applicant: Hefei Kaimeng Technology Co., Ltd., Anhui (CN)

(72) Inventors: Kuai Cao, Anhui (CN); Tsung-Lin Wu, Anhui (CN); Qiao ZHU, Anhui (CN); Yang Chen, Anhui (CN); Dong Dong Yao, Anhui (CN)

(73) Assignee: Hefei Kaimeng Technology Co., Ltd., Anhui (CN)

(21) Appl. No.: 19/663,224

(22) Filed: Apr. 29, 2026

(30) Foreign Application Priority Data
May 26, 2025 (CN) 202510684666.1

(51) Int. Cl. G06F 3/06

(52) U.S. Cl. CPC G06F 3/0604; G06F 3/0659; G06F 3/0679

(57) ABSTRACT

The present disclosure provides a memory management method and a memory controller for a storage device configured with a memory module. The method obtains a continuity status table, identifies a target mapping table and obtains its continuity status based on a data access command and the continuity status table, determines whether to use a contiguous segment mapping table based on the continuity status, loads the contiguous segment mapping table to a buffer memory if determined to use it, or loads the target mapping table to the buffer memory if determined not to use it, and obtains a physical address based on the loaded mapping table to access the memory module. The present disclosure dynamically selects the optimal mapping table processing approach by evaluating the contiguity of physical addresses in the mapping table, effectively improving data access performance and optimizing buffer memory utilization efficiency.

### CROSS-REFERENCE TO RELATED APPLICATION

This application claims the priority benefit of China application serial no. 202510684666.1, filed on May 26, 2025. The entirety of the above-mentioned patent application is hereby incorporated by reference herein and made a part of this specification.

### BACKGROUND

### Technical Field

The present disclosure relates to the field of storage technology, and in particular to a memory management method and a memory controller, aimed at improving the read performance of a storage device.

### Description of Related Art

In modern flash memory storage devices, the conversion from a logical address to a physical address is implemented through a mapping table.

Conventionally, an entire mapping table read from flash memory is stored directly in the buffer memory of the controller, so as to reduce the number of repeated loads of the mapping table. This approach is effective for mapping tables with relatively discrete physical addresses, maintaining a range in which the mapping table does not need to be repeatedly read from flash memory. However, this approach is relatively dependent on buffer memory size, and for mapping tables with relatively contiguous physical addresses, the approach of keeping the mapping table directly resident in the buffer memory does not achieve high resource utilization efficiency.

### SUMMARY

In view of this, the present disclosure provides a memory management method and a memory controller for mapping table processing, which dynamically selects the optimal mapping table processing approach by evaluating the contiguity of physical addresses in the mapping table, so as to improve read performance and optimize buffer memory resource utilization.

One or more embodiments of the present disclosure provide a memory management method applied to a storage device configured with a memory module. The method includes: obtaining a continuity status table, wherein the continuity status table is used to characterize the continuity status of a physical address arrangement in at least one mapping table; identifying, based on a data access command and the continuity status table, a target mapping table corresponding to the data access command, and obtaining a target continuity status of the target mapping table; and determining, based on the target continuity status, an execution strategy for the data access command, so as to complete an access operation of target data.

In one or more embodiments of the present disclosure, the method of determining the execution strategy for the data access command based on the target continuity status includes: determining, based on the target continuity status, whether to use a contiguous segment mapping table corresponding to the target mapping table; if determined to use the contiguous segment mapping table, loading the contiguous segment mapping table to the buffer memory of the storage device; and obtaining, based on the contiguous segment mapping table, a physical address corresponding to the data access command, so as to complete the access operation of the target data.

In one or more embodiments of the present disclosure, the method further includes: if determined not to use the contiguous segment mapping table, loading the target mapping table to the buffer memory; and obtaining, based on the target mapping table, a physical address corresponding to the data access command, so as to complete the access operation of the target data.

In one or more embodiments of the present disclosure, the continuity status of the physical address arrangement in each of the mapping tables is one of a first state, a second state, and a third state; the contiguous segment mapping table corresponding to the target mapping table includes a plurality of pieces of contiguous segment information, each piece of contiguous segment information including at least a plurality of contiguous logical addresses and a plurality of contiguous physical addresses.

In one or more embodiments of the present disclosure, prior to obtaining the continuity status table, the method further includes: maintaining the continuity status table, wherein when updating the at least one mapping table, analyzing the distribution characteristics of the plurality of physical addresses involved, so as to calculate the corresponding update physical address contiguity coverage rate; when the update physical address contiguity coverage rate is higher than a first preset coverage rate threshold, determining the continuity status of the mapping table as the first state; when the update physical address contiguity coverage rate is lower than a second preset coverage rate threshold, determining the continuity status of the mapping table as the second state; and when the number of physical addresses involved in the update is lower than a preset quantity threshold, or the update physical address contiguity coverage rate is between the first preset coverage rate threshold and the second preset coverage rate threshold, determining the continuity status of the mapping table as the third state.

In one or more embodiments of the present disclosure, the determining, based on the target continuity status, whether to use the contiguous segment mapping table corresponding to the target mapping table includes: if the target continuity status is the first state, determining to use the contiguous segment mapping table, wherein the contiguous segment mapping table has been pre-built when the system is idle; if the target continuity status is the second state, determining not to use the contiguous segment mapping table; and if the target continuity status is the third state, determining to use the contiguous segment mapping table, wherein the contiguous segment mapping table is built when processing the data access command.

In one or more embodiments of the present disclosure, the building of the contiguous segment mapping table includes: analyzing all physical addresses in the target mapping table, and calculating the number of contiguous segments and the full-table physical address contiguity coverage rate of the built contiguous segment mapping table; if the number of contiguous segments is less than the preset segment count threshold and the full-table physical address contiguity coverage rate is higher than a third preset coverage rate threshold, determining that the build is successful, loading the contiguous segment mapping table to the buffer memory, and updating the target continuity status to the first state; and if the number of contiguous segments is not less than the preset segment count threshold or the full-table physical address contiguity coverage rate is not higher than the third preset coverage rate threshold, determining that the build has failed, loading the target mapping table to the buffer memory, and updating the target continuity status to the second state.

In one or more embodiments of the present disclosure, the update physical address contiguity coverage rate and the full-table physical address contiguity coverage rate adopt the same calculation method, including: analyzing address differences between adjacent physical addresses in a target physical address sequence to be evaluated; identifying one or more contiguous physical address subsequences having a fixed preset difference value, and dividing them into a plurality of contiguous segments; calculating the sum of the number of physical addresses included in all of the contiguous segments; and dividing the sum of the number of physical addresses by the total number of addresses in the target physical address sequence, so as to obtain the corresponding contiguous address coverage rate.

In one or more embodiments of the present disclosure, the method further includes: monitoring the resource usage of the buffer memory; executing a first management mechanism or a second management mechanism for managing the use of a plurality of buffer storage units in the buffer memory, wherein each buffer storage unit is configured to cache one or more mapping tables or one or more contiguous segment mapping tables, wherein the first management mechanism includes continuously performing hit count statistics on the plurality of buffer storage units in the buffer memory, wherein the second management mechanism includes maintaining a cache queue structure for managing the plurality of buffer storage units in the buffer memory, and moving a particular buffer storage unit that is accessed to the tail of the queue; when the available space of the buffer memory is lower than a preset space threshold: if the first management mechanism is adopted, selecting a first target buffer storage unit with a hit count lower than a hit count threshold to evict; and if the second management mechanism is adopted, selecting a second target buffer storage unit from the head of the queue to evict.

In one or more embodiments of the present disclosure, the contiguous segment information is stored in one of the following forms: a first form, including: a start logical address, indicating the first logical address in the contiguous segment; a start physical address, indicating the physical address corresponding to the start logical address; and a segment length, indicating the number of consecutive addresses in the contiguous segment; and a second form, including: a start logical address and an end logical address, respectively indicating the first and last logical addresses in the contiguous segment; and a start physical address and an end physical address, respectively indicating the physical addresses corresponding to the start logical address and the end logical address.

In one or more embodiments of the present disclosure, the method further includes: before the storage device is powered off, storing the continuity status table to the memory module; for one or more mapping tables whose continuity status in the continuity status table is the first state, storing one or more contiguous segment mapping tables corresponding to the one or more mapping tables to the memory module; when the storage device is powered on, loading the continuity status table from the memory module to the buffer memory; and in response to a data access operation corresponding to one of the one or more mapping tables, loading the corresponding contiguous segment mapping table from the memory module.

In one or more embodiments of the present disclosure, the method further includes: when the system is in an idle state, selecting, from the continuity status table, another target mapping table whose continuity status is the second state; performing a garbage collection operation on a plurality of source physical blocks corresponding to the other target mapping table, so as to store valid data corresponding to the plurality of source physical blocks into a plurality of other target physical blocks; updating the mapping relationship between logical addresses and physical addresses in the other target mapping table, so as to obtain the continuity status of the other target mapping table; and if the continuity status of the other target mapping table is the first state, building and storing the contiguous segment mapping table corresponding to the other target mapping table to the memory module.

One or more embodiments of the present disclosure provide a memory controller for controlling a storage device configured with a memory module. The memory controller includes: a memory interface control circuit electrically connected to the memory module; and a processor electrically connected to the memory interface control circuit, wherein the processor is further electrically connected to a connection interface circuit of the storage device to electrically connect to a host system, wherein the processor is configured to: obtain a continuity status table, wherein the continuity status table is used to characterize the continuity status of a physical address arrangement in at least one mapping table; identify, based on a data access command and the continuity status table, a target mapping table corresponding to the data access command, and obtain a target continuity status of the target mapping table; and determine, based on the target continuity status, an execution strategy for the data access command, so as to complete an access operation of target data.

Based on the above, the memory management method and memory controller provided by the present disclosure can accurately identify the characteristics of different mapping tables by obtaining the respective continuity status of a plurality of mapping tables, providing a basis for subsequent processing. The continuity status directly reflects the degree of contiguity of physical address arrangements in a mapping table. By identifying the target mapping table and obtaining its continuity status, the system is enabled to select the most suitable mapping table processing approach for a specific data access command. For mapping tables with good contiguity, using the contiguous segment mapping table can reduce the occupation of buffer memory; for mapping tables with poor contiguity, directly using the complete mapping table can avoid ineffective contiguity analysis. The present disclosure selects to load the contiguous segment mapping table or the target mapping table to the buffer memory based on the determination result, utilizing buffer memory space resources more efficiently. By loading only necessary mapping information, the present disclosure reduces buffer memory occupation, improves the overall efficiency and resource utilization of the storage device, and is particularly applicable to storage application scenarios with limited resources or requiring high performance.

### BRIEF DESCRIPTION OF THE DRAWINGS

FIG. 1 is a block diagram of a host system and a storage device according to an embodiment of the present disclosure.

FIG. 2 is a flowchart of a memory management method according to an embodiment of the present disclosure.

FIG. 3 is a detailed flowchart of mapping table management according to an embodiment of the present disclosure.

FIG. 4 is a schematic structural diagram of a continuity status table according to an embodiment of the present disclosure.

FIG. 5 is a schematic diagram of buffer storage unit management based on hit count according to an embodiment of the present disclosure.

FIG. 6 is a schematic diagram of buffer storage unit management based on queue management according to an embodiment of the present disclosure.

### DESCRIPTION OF THE EMBODIMENTS

Reference will now be made in detail to exemplary embodiments of the present disclosure, examples of which are illustrated in the accompanying drawings. Wherever possible, the same reference numerals are used in the drawings and descriptions to represent the same or similar parts.

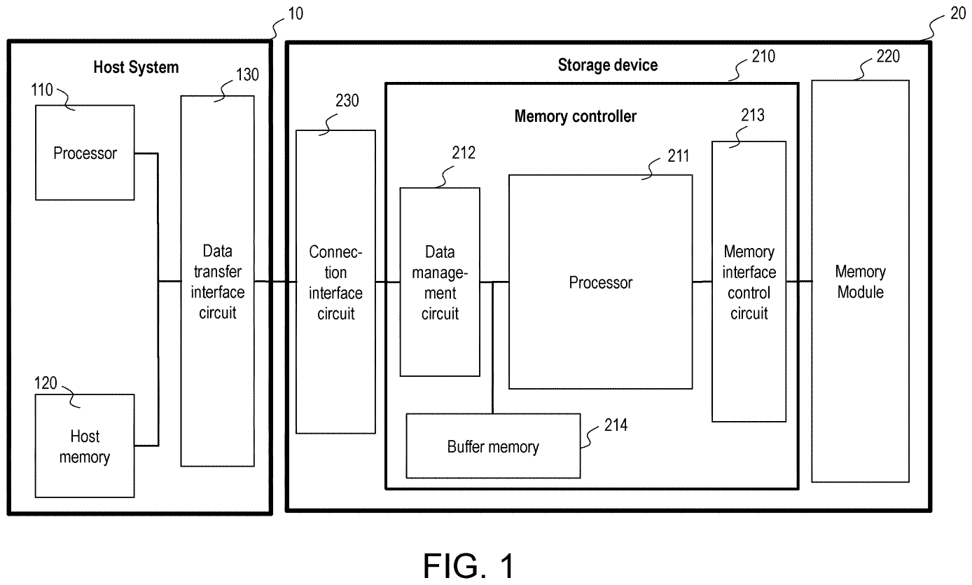

FIG. 1 is a block diagram illustrating a host system and a storage device according to an embodiment of the present disclosure. Referring to FIG. 1, the host system 10 is, for example, a personal computer, a laptop computer, or a server. The host system (Host System) 10 comprises a processor (Processor) 110 (also referred to as a second processor), a host memory (Host Memory) 120 (also referred to as host memory), and a data transfer interface circuit (Data Transfer Interface Circuit) 130. In the present embodiment, the processor 110 is coupled to (also referred to as electrically connected to) the host memory 120 and the data transfer interface circuit 130. In another embodiment, the processor (Processor) 110, the host memory 120, and the data transfer interface circuit 130 are electrically connected to one another via a system bus (System Bus). In the present embodiment, the processor 110, the host memory 120, and the data transfer interface circuit 130 may be disposed on a motherboard of the host system 10.

The storage device 20 comprises a memory controller (Memory Controller) 210, a memory module (Memory Module) 220 (also referred to as a rewritable non-volatile memory module (Rewritable Non-Volatile Memory Module)), and a connection interface circuit (Connection Interface Circuit) 230. The memory controller 210 comprises a processor 211 (also referred to as a first processor), a data management circuit (Data Management Circuit) 212, a memory interface control circuit (Memory Interface Control Circuit) 213, and a buffer memory 214.

In the present embodiment, the host system 10 performs data access operations by being electrically connected to the storage device 20 via the data transfer interface circuit 130 and the connection interface circuit 230 of the storage device 20. For example, the host system 10 may store data into the storage device 20 or read data from the storage device 20 via the data transfer interface circuit 130.

In the present embodiment, the number of data transfer interface circuits 130 may be one or more. Via the data transfer interface circuit 130, the motherboard may be electrically connected to the storage device 20 in a wired or wireless manner. The storage device 20 may be, for example, a USB flash drive, a memory card, a Solid State Drive (SSD), or a wireless memory storage device. The wireless memory storage device may be, for example, a Near Field Communication (NFC) memory storage device, a WiFi memory storage device, a Bluetooth memory storage device, or a low-power Bluetooth memory storage device (e.g., iBeacon), and other memory storage devices based on various wireless communication technologies. In addition, the motherboard may also be electrically connected via a system bus to various I/O devices such as a Global Positioning System (GPS) module, a network interface card, a wireless transmission device, a keyboard, a display, and a speaker.

In the present embodiment, the data transfer interface circuit 130 and the connection interface circuit 230 are interface circuits compatible with the Peripheral Component Interconnect Express (PCI Express) standard. Furthermore, data is transmitted between the data transfer interface circuit 130 and the connection interface circuit 230 using the Non-Volatile Memory express (NVMe) communication protocol.

In addition, in another embodiment, the connection interface circuit 230 may be packaged together with the memory controller 210 in a single chip, or the connection interface circuit 230 may be disposed outside a chip that includes the memory controller 210.

In the present embodiment, the host memory 120 is configured to temporarily store instructions or data executed by the processor 110. In the present embodiment, the host memory 120 may be a Dynamic Random Access Memory (DRAM), a Static Random Access Memory (SRAM), or the like. However, it should be understood that the present disclosure is not limited thereto, and the host memory 120 may also be other suitable memory.

The memory controller 210 is configured to execute a plurality of logic gates or control instructions implemented in hardware form or firmware form, and to perform operations such as write, read, and erase of data in the memory module 220 according to instructions from the host system 10.

In more detail, the processor 211 in the memory controller 210 is hardware with computing capability, configured to control the overall operation of the memory controller 210. The processor 211 is configured to execute the memory management method provided by the present disclosure. Specifically, the processor 211 is configured to: obtain a continuity status of each of a plurality of mapping tables, the continuity status being configured to indicate a degree of contiguous arrangement of a plurality of physical addresses corresponding to a plurality of logical addresses in a corresponding mapping table; according to a data access command, identify a target mapping table corresponding to the data access command among the plurality of mapping tables, and obtain a target continuity status corresponding to the target mapping table; according to the target continuity status, determine whether to use a contiguous segment mapping table corresponding to the target mapping table; and load a corresponding mapping table into the buffer memory 214 according to the determination result, and obtain a physical address corresponding to the data access command, so as to access the memory module 220. In other embodiments, the control instructions/program code corresponding to the data read method may further be implemented as circuit units in hardware form, so as to implement the memory management method provided by the present disclosure.

It is worth noting that in the present embodiment, the processor 110 and the processor 211 are, for example, a Central Processing Unit (CPU), a micro-processor, or other programmable processing units (Microprocessor), a Digital Signal Processor (DSP), a programmable controller, an Application Specific Integrated Circuit (ASIC), a Programmable Logic Device (PLD), or other similar circuit components, and the present disclosure is not limited thereto.

In the present embodiment, as described above, the memory controller 210 further comprises the data management circuit 212 and the memory interface control circuit 213. It should be noted that operations performed by individual components of the memory controller 210 may also be regarded as operations performed by the memory controller 210.

The data management circuit 212 is electrically connected to the processor 211, the memory interface control circuit 213, and the connection interface circuit 230. The data management circuit 212 is configured to accept instructions from the processor 211 to perform data transmission. For example, the data management circuit 212 reads data from the host system 10 (e.g., the host memory 120) via the connection interface circuit 230, and writes the read data into the memory module 220 via the memory interface control circuit 213 (e.g., performing corresponding write operations according to various write commands from the host system 10). As another example, the data management circuit 212 performs a read operation according to a read command from the host system 10, reads data from one or more physical units of the memory module 220 via the memory interface control circuit 213 (data may be read from one or more storage units within one or more physical units), and writes the read data into the host system 10 (e.g., the host memory 120) via the connection interface circuit 230. In another embodiment, the data management circuit 212 may also be integrated into the processor 211.

The memory interface control circuit 213 is configured to accept instructions from the processor 211, and to cooperate with the data management circuit 212 to perform write (also referred to as programming) operations, read operations, or erase operations on the memory module 220.

In addition, data to be written into the memory module 220 is converted into a format acceptable to the memory module 220 via the memory interface control circuit 213. Specifically, when the processor 211 accesses the memory module 220, the processor 211 transmits a corresponding command sequence to the memory interface control circuit 213 to instruct the memory interface control circuit 213 to perform a corresponding operation. For example, these command sequences may include a write command sequence for indicating data to be written, a read command sequence for indicating data to be read, an erase command sequence for indicating data to be erased, and corresponding command sequences for indicating various memory operations. These command sequences may comprise one or more signals, or data on a bus. These signals or data may include command codes or program codes. For example, a read command sequence includes information such as a read identifier, a memory address, and a physical address. It is noted that the data access commands mentioned in the present disclosure may refer to a read command sequence or a write command sequence generated by the processor 211, or a read command or write command from the host system 10.

In addition, the memory controller 210 establishes various mapping tables, for example, a logical-to-physical address mapping table (Logical To Physical address mapping table) and a physical-to-logical address mapping table (Physical To Logical address mapping table), so as to record the mapping relationship between logical addresses of logical units (e.g., logical blocks, logical pages) allocated to the memory module 220 and physical addresses of physical units (e.g., physical erase units/physical blocks, physical pages). In other words, the memory controller 210 may look up a physical unit mapped by a logical unit through the logical-to-physical address mapping table (also referred to as the logical-to-physical mapping table) (e.g., look up a physical page mapped by a logical page; look up a physical address mapped by a logical address), and the memory controller 210 may look up a logical unit mapped by a physical unit through the physical-to-logical address mapping table (also referred to as the physical-to-logical mapping table) (e.g., look up a logical page mapped by a physical page; look up a logical address mapped by a physical address).

The buffer memory 214 is electrically connected to the processor 211, and is configured to temporarily store data and instructions from the host system 10, data from the memory module 220, and various system data for managing the storage device 20, such as contiguous segment mapping tables, continuity status tables, cache queues, buffer storage unit hit count tables, and other system data related to various embodiments of the present disclosure.

The memory module 220 is electrically connected to the memory controller 210 (specifically, electrically connected to the memory interface control circuit 213) and is configured to store user data transmitted by the host system 10. The memory module 220 has a specific physical structure to support the memory management method of the present disclosure. Specifically, the memory module 220 comprises a plurality of chips. Each chip is further subdivided internally into a plurality of planes, and each plane comprises a plurality of physical blocks. In addition, each physical block in the memory module 220 further comprises a plurality of physical pages, and each physical page comprises a plurality of memory cells. It should be noted that the present disclosure is not limited to the size of each physical page and logical page.

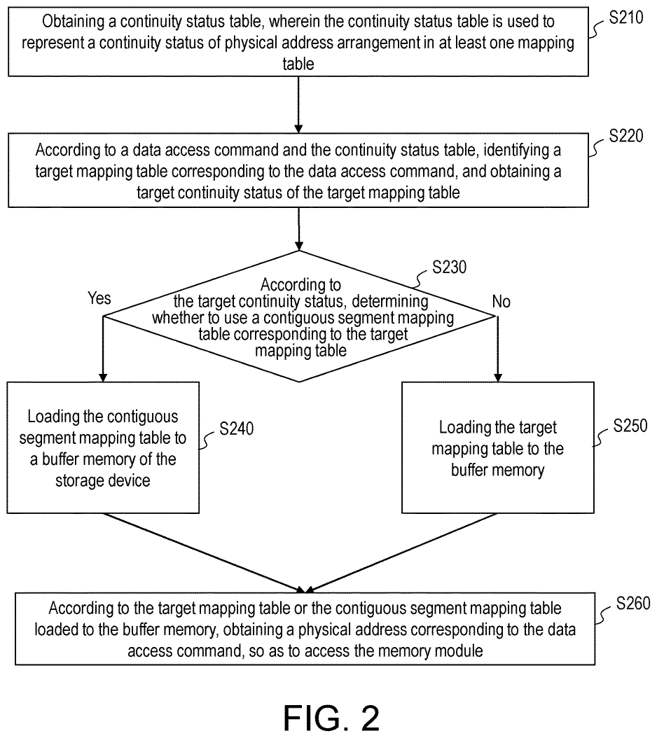

FIG. 2 illustrates a flowchart of a memory management method according to an embodiment of the present disclosure.

Referring to FIG. 2, in an embodiment, the processor 211 is configured to execute a memory management method, the method comprising the following steps:

In step S210, the processor 211 obtains a continuity status table, the continuity status table configured to characterize a continuity status of physical address arrangements in at least one mapping table.

In an embodiment, the processor 211 maintains a continuity status table for recording the continuity status of each of the plurality of mapping tables.

The continuity status may include a first state, a second state, and a third state. The first state indicates that the contiguity of the mapping table is relatively good, and is suitable for building a contiguous segment mapping table; the second state indicates that the contiguity of the mapping table is relatively poor, and is not suitable for building a contiguous segment mapping table; the third state indicates that the contiguity of the mapping table is uncertain, and an attempt to build a contiguous segment mapping table is required. In the continuity status table of the storage device 20, the processor 211 may use 2 bits to represent the continuity status of each mapping table, for example, “00” represents the first state, “10” represents the second state, and “01” represents the third state.

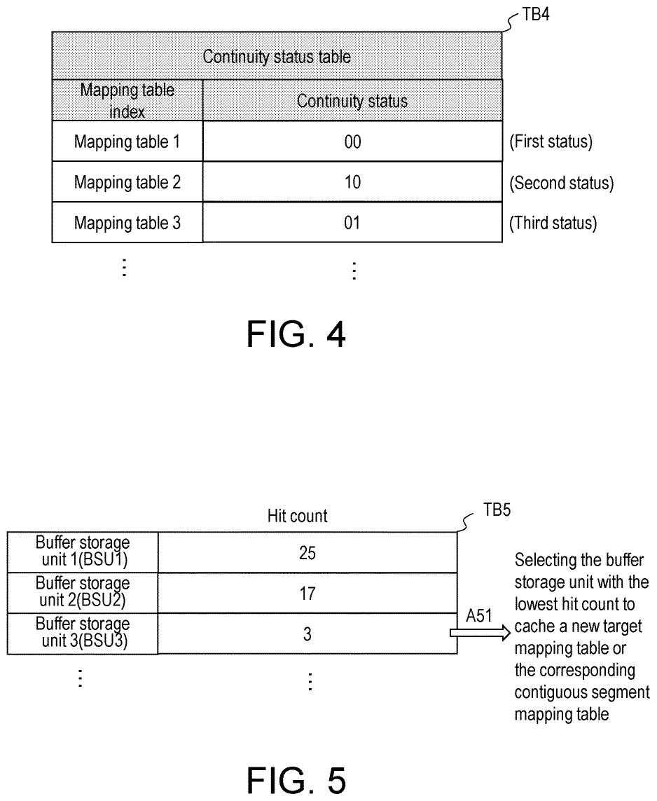

FIG. 4 illustrates a structural diagram of a continuity status table according to an embodiment of the present disclosure. Referring to FIG. 4, in an embodiment, the processor 211 maintains a continuity status table TB4 for recording the continuity status of each of the plurality of mapping tables. The continuity status table may utilize the buffer memory 214 or specific registers to record the relevant information.

As shown in FIG. 4, the continuity status table TB4 comprises two main fields: a mapping table index and a continuity status. The mapping table index field is configured to uniquely identify each mapping table in the storage device 20, such as mapping table 1, mapping table 2, mapping table 3, and so on. The continuity status field is configured to record the continuity status of the corresponding mapping table, using 2 bits to represent three different states.

In the present embodiment, “00” in the continuity status represents the first state, indicating that the contiguity of the corresponding mapping table (e.g., mapping table 1) is relatively good, and is suitable for building a contiguous segment mapping table; “10” represents the second state, indicating that the contiguity of the corresponding mapping table (e.g., mapping table 2) is relatively poor, and is not suitable for building a contiguous segment mapping table; “01” represents the third state, indicating that the contiguity of the corresponding mapping table (e.g., mapping table 3) is uncertain, and an attempt to build a contiguous segment mapping table is required.

During the operation of the storage device 20, the processor 211 dynamically updates the state values in the continuity status table TB4 according to updates to the mapping tables resulting from data access operations. When the processor 211 receives a data access command, the processor 211 identifies a corresponding target mapping table according to a logical address contained in the command, queries the continuity status of the target mapping table from the continuity status table TB4, and then determines whether to use the contiguous segment mapping table or the complete target mapping table.

For example, when the processor 211 needs to access the address region corresponding to mapping table 1, the processor 211 determines, by querying the continuity status table TB4, that the continuity status of mapping table 1 is “00” (the first state), and the processor 211 will directly use the pre-built contiguous segment mapping table. When it is necessary to access the address region corresponding to mapping table 2, the queried continuity status is “10” (the second state), and the processor 211 will use the complete mapping table 2. When it is necessary to access the address region corresponding to mapping table 3, the queried continuity status is “01” (the third state), and the processor 211 will attempt to build a contiguous segment mapping table.

In this way, the continuity status table TB4 provides the processor 211 with a rapid index of the contiguity characteristics of the mapping tables, enabling the processor 211 to efficiently select the most suitable mapping table processing method and optimize resource utilization of the buffer memory 214.

In addition, since the storage space requirement of the continuity status table TB4 is relatively small (only 2 bits per mapping table), it may reside permanently in the buffer memory 214, further improving the efficiency of data access operations.

It should be noted that, in another embodiment, the continuity status may use only 1 bit to record the first state and the second state. When the quantity of stored physical addresses is too small, the processor 211 may analyze the entire target mapping table to determine whether the continuity status of the target mapping table is the first state or the second state, and record the result into the continuity status table.

In an embodiment, when updating (or accessing) one of the plurality of mapping tables, the processor 211 analyzes distribution characteristics of the plurality of physical addresses involved in the update, so as to calculate a corresponding update physical address contiguity coverage rate. Specifically, the processor 211 performs the following operations: when the update physical address contiguity coverage rate is higher than a first preset coverage rate threshold, determining that the continuity status of the mapping table is the first state; when the update physical address contiguity coverage rate is lower than a second preset coverage rate threshold, determining that the continuity status of the mapping table is the second state; and when a quantity of physical addresses involved in the update is lower than a preset quantity threshold, or the update physical address contiguity coverage rate is between the first preset coverage rate threshold and the second preset coverage rate threshold, determining that the continuity status of the mapping table is the third state.

For example, in a specific example, the first preset coverage rate threshold may be set to 80%, and the second preset coverage rate threshold may be set to 30%. If the processor 211 determines through analysis that the update physical address contiguity coverage rate of a certain mapping table is 85%, this indicates that most physical addresses in the mapping table exhibit a contiguous distribution, and the processor 211 sets the continuity status of the mapping table to the first state. If the analysis reveals that the update physical address contiguity coverage rate of a certain mapping table is only 20%, this indicates that the physical addresses in the mapping table are relatively dispersed, and the processor 211 sets the continuity status of the mapping table to the second state. If the analysis reveals that the update physical address contiguity coverage rate of a certain mapping table is 60%, the processor 211 sets the continuity status of the mapping table to the third state. In this manner, the processor 211 is capable of dynamically adjusting the continuity status of the mapping table according to the actual distribution characteristics of the physical addresses.

In an embodiment, the method for calculating the update physical address contiguity coverage rate comprises: the processor 211 analyzing address differences between adjacent physical addresses in a target physical address sequence to be evaluated (e.g., a plurality of target physical addresses triggered corresponding to the current mapping table access operation); identifying one or more contiguous physical address subsequences having a fixed difference, and dividing them into a plurality of contiguous segments; calculating a sum of quantities of physical addresses contained in all of the contiguous segments; and dividing the sum of the quantities of physical addresses by a total address quantity of the target physical address sequence, so as to obtain a corresponding contiguous address coverage rate.

For example, assume that the processor 211 needs to evaluate a sequence (target physical address sequence) containing 10 physical addresses: {100, 101, 102, 105, 107, 108, 109, 200, 201, 202}. The processor 211 first calculates the differences between adjacent addresses, yielding {1, 1, 3, 2, 1, 1, 91, 1, 1}. Contiguous subsequences having a fixed preset difference (e.g., a preset difference of 1) are then identified, yielding three contiguous segments: {100, 101, 102}, {107, 108, 109}, and {200, 201, 202}, each containing 3 addresses. The total number of addresses in all contiguous segments is 9, which accounts for 90% of the total sequence length; therefore, the contiguous address coverage rate of the sequence is 90%. The specific value of the fixed preset difference is set according to the definition of adjacent physical addresses for each memory module.

In step S220, the processor 211 identifies, according to the data access command, a target mapping table corresponding to the data access command from among the plurality of mapping tables, and obtains a target continuity status corresponding to the target mapping table.

In an embodiment, the processor 211 receives a data access command from the host system 10, the command comprising a logical address to be accessed. The processor 211 determines a corresponding target mapping table according to the logical address (e.g., the plurality of logical addresses recorded in the target mapping table includes the logical address to be accessed), and queries the continuity status of the target mapping table from the continuity status table.

After obtaining the target continuity status, the processor 211 may determine an execution strategy for the data access command according to the target continuity status, so as to complete an access operation of the target data. The specific procedure is as described in steps S230 to S260.

In step S230, the processor 211 identifies, according to the data access command and the continuity status table, a target mapping table corresponding to the data access command, and obtains a target continuity status of the target mapping table.

In an embodiment, the processor 211 performs the following determination operations according to the target continuity status: if the target continuity status is the first state, the processor 211 determines to use the contiguous segment mapping table corresponding to the target mapping table, wherein the contiguous segment mapping table has been pre-built when the system is idle; if the target continuity status is the second state, the processor 211 determines not to use the contiguous segment mapping table corresponding to the target mapping table; and if the target continuity status is the third state, the processor 211 determines to use the contiguous segment mapping table corresponding to the target mapping table, wherein the contiguous segment mapping table is built in real time when processing the data access command.

Specifically, in an embodiment, for a target mapping table whose continuity status is the first state, the processor 211 does not need to rebuild the contiguous segment mapping table, because the contiguous segment mapping table has been pre-built when the system is idle and stored in the memory module 220 or the buffer memory 214. The processor 211 only needs to load it into the buffer memory 214 or use it directly.

This pre-building approach can reduce the latency of data access operations. In another embodiment, for a target mapping table whose continuity status is the first state, the processor 211 directly builds the contiguous segment mapping table in real time without verifying whether the contiguity of the built contiguous segment mapping table is satisfactory.

In an embodiment, for a target mapping table whose continuity status is the third state, since its contiguity has not yet been determined, the processor 211 builds the contiguous segment mapping table in real time during the processing of the current data access command, and determines the subsequent processing approach based on the building result (i.e., the contiguity of the contiguous segment mapping table). For a target mapping table whose continuity status is the second state, since the physical addresses are relatively dispersed, the benefit of building a contiguous segment mapping table is limited, and the processor 211 directly uses the complete target mapping table.

In an embodiment, when building the contiguous segment mapping table, the processor 211 analyzes all physical addresses in the target mapping table and calculates a segment count and a full-table physical address contiguity coverage rate of the built contiguous segment mapping table. If the segment count is less than a preset segment count threshold and the full-table physical address contiguity coverage rate is higher than a third preset coverage rate threshold, the processor 211 determines that the building is successful, loads the contiguous segment mapping table into the buffer memory 214, and updates the target continuity status to the first state. If the segment count is not less than the preset segment count threshold or the full-table physical address contiguity coverage rate is not higher than the third preset coverage rate threshold, the processor 211 determines that the building has failed, loads the target mapping table into the buffer memory 214, and updates the target continuity status to the second state.

In an embodiment, when the processor 211 determines the continuity status of a target mapping table, a variety of threshold settings are required to ensure the accuracy of the determination. In addition to the aforementioned coverage rate thresholds, the determination of the segment count is also one of the key factors. The segment count reflects the degree of dispersion of physical address distribution in the mapping table. A higher segment count indicates a higher degree of dispersion in the mapping table. Even if the overall coverage rate may be relatively high, a large number of segment transitions may still affect read efficiency.

Specifically, if the number of contiguous segments is excessive, even when the segments cover most of the physical addresses, using the contiguous segment mapping table may still be less efficient than directly using the complete mapping table, because each address lookup may require comparison and matching across multiple segments. The processor 211 controls this factor by setting the preset segment count threshold, ensuring that the continuity status of the mapping table is determined to be the first state only when the number of contiguous segments is sufficiently small and the coverage rate is sufficiently high.

For example, assume the preset segment count threshold is 10 and the third preset coverage rate threshold is 75%. If the processor 211 analyzes the target mapping table and finds that the built contiguous segment mapping table comprises 8 contiguous segments and the full-table physical address contiguity coverage rate is 85%, then the conditions that the segment count is less than the preset segment count threshold (8<10) and the full-table physical address contiguity coverage rate is higher than the third preset coverage rate threshold (85%>75%) are both satisfied, and the building is determined to be successful.

If the built contiguous segment mapping table comprises 12 contiguous segments, even when the full-table physical address contiguity coverage rate is 80%, the building is determined to have failed because the segment count is not less than the preset segment count threshold (12≥10). Similarly, if the segment count is 5 but the full-table physical address contiguity coverage rate is only 70%, the building is also determined to have failed because the full-table physical address contiguity coverage rate is not higher than the third preset coverage rate threshold (70%≤75%).

In a particular implementation, the processor 211 may dynamically adjust the preset segment count threshold based on the specific characteristics and performance requirements of the storage device 20. For high-performance storage devices having a larger buffer memory 214, a higher preset segment count threshold may be set to allow more contiguous segments; whereas for resource-constrained embedded storage devices, a lower preset segment count threshold may be set to prioritize the space efficiency of the buffer memory 214.

In an embodiment, the full-table physical address contiguity coverage rate is calculated using the same calculation method as the update physical address contiguity coverage rate, comprising: analyzing address differences between adjacent physical addresses in a target physical address sequence to be evaluated (e.g., the valid physical addresses of the entire target mapping table); identifying one or more contiguous physical address subsequences having a fixed preset difference, and dividing them into a plurality of contiguous segments; calculating a sum of quantities of physical addresses contained in all of the contiguous segments; and dividing the sum of the quantities of physical addresses by a total address quantity of the target physical address sequence, so as to obtain a corresponding contiguous address coverage rate.

In step S240, if it is determined to use the contiguous segment mapping table corresponding to the target mapping table, the processor 211 loads the contiguous segment mapping table into the buffer memory 214 of the storage device 20. Specifically, if the target continuity status is the first state, the processor 211 determines to use the contiguous segment mapping table corresponding to the target mapping table.

In an embodiment, if the contiguous segment mapping table has already been stored in the memory module 220, the processor 211 may directly load the contiguous segment mapping table from the memory module 220 into the buffer memory 214.

In another embodiment, if the contiguous segment mapping table has not yet been stored in the memory module 220 or the buffer memory 214, the processor 211 may build the contiguous segment mapping table in real time into the buffer memory 214. In another embodiment, if the contiguous segment mapping table has already been stored in the buffer memory 214, the processor 211 may use it directly.

In an embodiment, the contiguous segment mapping table corresponding to the target mapping table comprises a plurality of contiguous segment information, each contiguous segment information comprising at least a plurality of contiguous logical addresses and a plurality of contiguous physical addresses.

Specifically, the contiguous segment information may be stored in one of the following forms: a first form, comprising a starting logical address, a starting physical address, and a segment length, wherein the starting logical address indicates a first logical address in the contiguous segment, the starting physical address indicates a physical address corresponding to the starting logical address, and the segment length indicates a quantity of consecutive addresses in the contiguous segment; and a second form, comprising a starting logical address, an ending logical address, a starting physical address, and an ending physical address, wherein the starting logical address and the ending logical address indicate a first logical address and a last logical address in the contiguous segment, respectively, and the starting physical address and the ending physical address indicate physical addresses corresponding to the starting logical address and the ending logical address, respectively.

For example, for the first form, if the logical addresses of a contiguous segment are {1000, 1001, 1002, 1003, 1004} and the corresponding physical addresses are {5000, 5001, 5002, 5003, 5004}, the processor 211 may store the contiguous segment information as: starting logical address=1000, starting physical address=5000, segment length=5. For the second form, the processor 211 may store the same contiguous segment information as: starting logical address=1000, ending logical address=1004, starting physical address=5000, ending physical address=5004. By means of the contiguous segment information, the processor 211 may determine a physical address corresponding to any logical address within the contiguous segment without storing all address mapping relationships within the contiguous segment, thereby saving space of the buffer memory 214.

In step S250, if it is determined not to use the contiguous segment mapping table corresponding to the target mapping table, the processor 211 loads the target mapping table into the buffer memory 214.

In an embodiment, when the processor 211 determines that the target continuity status is the second state, or when the target continuity status is the third state but the building of the contiguous segment mapping table has failed, the processor 211 reads the complete target mapping table from the memory module 220 and loads it into the buffer memory 214.

In step S260, the processor 211 obtains a physical address corresponding to the data access command according to the target mapping table or the contiguous segment mapping table loaded into the buffer memory 214, so as to access the memory module 220.

In an embodiment, regardless of whether the contiguous segment mapping table or the complete target mapping table is used, the processor 211 is able to look up a physical address corresponding to a logical address in the data access command. The processor 211 then performs a corresponding read operation or write operation in the memory module 220 via the memory interface control circuit 213 according to the physical address.

In an embodiment, when the processor 211 receives a data read command, the processor 211 executes a specific mapping table processing flow so as to optimize read performance. For data read operations, quickly obtaining the correct physical address is critical, and therefore the processor 211 adopts different processing strategies according to the characteristics of the read command and the continuity status of the corresponding mapping table.

Specifically, in an embodiment, when a large chunk size read command is received, if the continuity status of the target mapping table is the first state, the processor 211 loads the complete contiguous segment mapping table into the buffer memory 214, so as to obtain all mapping relationships that may be needed in a single operation. This approach is particularly suitable for scenarios involving reading large amounts of data consecutively, capable of reducing the number of repeated mapping table loads and improving read efficiency.

In another embodiment, when a small chunk size read command is received, in order to optimize usage of the buffer memory 214, even if the continuity status of the target mapping table is the second state (poor contiguity), the processor 211 adopts an on-demand loading strategy, reading only the minimum necessary portion of the mapping table (e.g., a 2 KB segment) rather than the entire mapping table (e.g., 16 KB). This differentiated loading strategy dynamically adjusts the loading range of the mapping table according to the characteristics of the read command, so as to optimize usage of the buffer memory 214 while ensuring read performance.

In an embodiment, assuming the host system 10 sends a command requesting to read 512 KB of contiguous data, the processor 211 detects this as a large chunk data read. If the continuity status of the corresponding mapping table is the first state, the complete contiguous segment mapping table is loaded; if it is the second state, the complete 16 KB mapping table is directly loaded; if it is the third state, an attempt is made to build the contiguous segment mapping table, and subsequent processing is determined based on the build result. For a small chunk read command that only needs to read 4 KB of data, if the continuity status of the mapping table is the second state, the processor 211 may load only a 2 KB mapping table segment, so as to conserve buffer memory 214 space.

This mapping table processing strategy based on the characteristics of read commands is capable of providing good performance and resource utilization efficiency across different read scenarios, and is particularly suitable for application scenarios that require simultaneous processing of large numbers of small files and large files.

In an embodiment, when the processor 211 receives a data write command, the potential impact of the write operation on the contiguity of the mapping table is taken into consideration, and a corresponding processing strategy is adopted. Data write operations generally modify the mapping relationship from logical addresses to physical addresses, which may alter the contiguity characteristics of the existing mapping table, and therefore require special handling.

In an embodiment, when a contiguous write command is received (e.g., writing a segment of contiguous large data), the processor 211 analyzes the distribution of physical addresses that may be used by the write operation. If the continuity status of the target mapping table is the first state or the third state, the processor 211 attempts to allocate contiguous physical addresses so as to maintain or improve the contiguity of the mapping table; if it is the second state, a more flexible allocation strategy may be adopted, with priority given to write efficiency and wear leveling.

In an embodiment, for contiguous data writes, the processor 211 may proactively select contiguous physical storage regions, even if this may temporarily sacrifice some wear leveling effect, because improving the contiguity of the mapping table can yield long-term performance benefits, particularly in typical usage scenarios where reads outnumber writes. The processor 211 re-evaluates the continuity status of the target mapping table upon completion of the write operation, and updates the continuity status table.

For example, when the host system 10 sends a command requesting to write 256 KB of contiguous data, the processor 211 attempts to find a sufficiently large contiguous physical address space. If found successfully and the write is completed, the physical addresses involved in the write operation will exhibit good contiguity, potentially improving the contiguous address coverage rate of the target mapping table. The processor 211 updates the continuity status of the mapping table accordingly. If the updated contiguous address coverage rate exceeds the first preset coverage rate threshold (e.g., 80%), the status is updated to the first state, and the corresponding contiguous segment mapping table is built for subsequent use.

Through this write-time optimization strategy, the storage device 20 is capable of continuously improving the contiguity characteristics of the mapping table during daily use, gradually increasing the proportion of contiguous segment mapping table usage, so as to continuously optimize performance and resource utilization efficiency over long-term operation.

Through the above flow steps, the processor 211 is capable of dynamically selecting the most suitable mapping table processing approach according to the contiguity characteristics of the mapping table, so as to optimize resource usage of the buffer memory 214 while maintaining read performance, and improve the overall efficiency of the storage device 20.

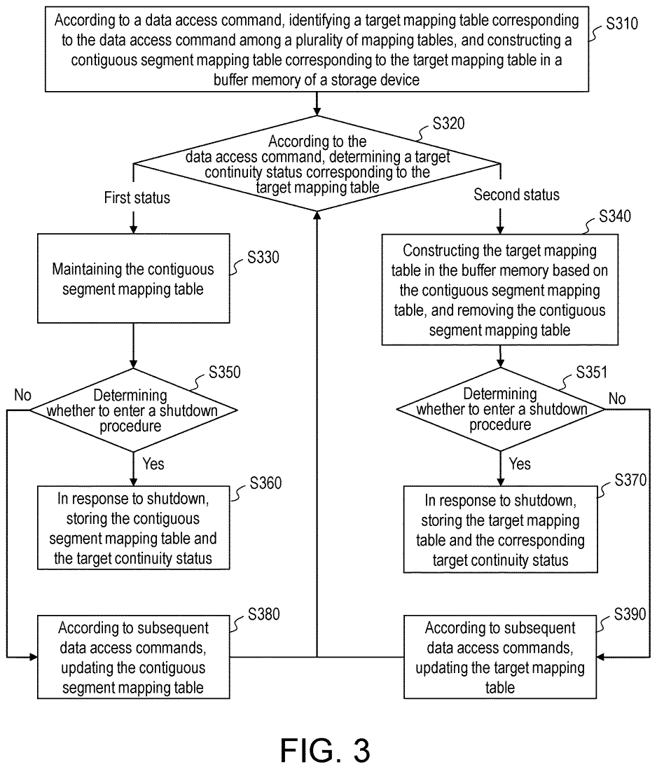

FIG. 3 illustrates a detailed flowchart of mapping table management according to an embodiment of the present disclosure.

Referring to FIG. 3, in an embodiment, the processor 211 is configured to execute a detailed flow of mapping table management. The flow particularly focuses on the pre-building and dynamic maintenance of the contiguous segment mapping table, as well as the processing approach when the system is powered off.

In the initial state of the storage device 20 or after a data reset, the processor 211 defaults to using the contiguous segment mapping table form to handle the recording of mapping relationships, based on the consideration that data writes in most application scenarios typically exhibit a certain degree of contiguity. As the storage device 20 continues to be used, the data distribution pattern may change, and the processor 211 adaptively adjusts the processing approach of the mapping table, so as to maintain good performance and resource utilization efficiency under different data distribution characteristics.

The method is characterized by its flexibility and adaptability. The processor 211 is capable not only of dynamically selecting whether to use the contiguous segment mapping table or the complete mapping table according to the continuity status of the mapping table, but also of continuously evaluating and updating this selection during system operation. More importantly, the system saves the current mapping table state and type prior to being powered off, so as to ensure that the most suitable mapping table processing approach can be quickly restored upon the next startup, thereby reducing the time cost of rebuilding the mapping table.

In step S310, the processor 211 identifies, according to the data access command, a target mapping table corresponding to the data access command among the plurality of mapping tables, and builds a contiguous segment mapping table corresponding to the target mapping table in the buffer memory 214 of the storage device 20.

In step S320, the processor 211 determines, according to the data access command, the target continuity status corresponding to the target mapping table. The determination step divides the target continuity status into two cases, namely the first state and the second state, corresponding to two branches of the process, respectively.

When the target continuity status is the first state (left branch):

In step S330, the processor 211 maintains the contiguous segment mapping table. In this step, because the continuity status of the target mapping table is the first state, indicating that the physical address distribution of the mapping table has good contiguity, the processor 211 selects to continue using the already-built contiguous segment mapping table without performing any conversion.

In step S350, the processor 211 determines whether to enter a shutdown procedure.

In step S360, if the determination result is yes, the processor 211, in response to shutdown, stores the contiguous segment mapping table and the target continuity status. Specifically, the processor 211 writes the contiguous segment mapping table and the continuity status table in the buffer memory 214 into the memory module 220, so as to enable quick recovery of the information upon the next startup and reduce the overhead of rebuilding the contiguous segment mapping table.

In an embodiment, the processor 211 is configured to perform a series of operations prior to the storage device 20 being powered off, so as to save state information related to mapping table management. Specifically, the processor 211 stores the continuity status table into the memory module 220, ensuring that the continuity status of the mapping tables can be restored upon the next startup. In addition, for one or more mapping tables whose continuity status is the first state (i.e., having relatively good contiguity), the processor 211 also stores the corresponding one or more contiguous segment mapping tables into the memory module 220. This differentiated storage strategy ensures that only those mapping tables having good contiguity characteristics are persistently stored in the form of contiguous segment mapping tables, thereby optimizing the use of storage space.

In an embodiment, upon the storage device 20 being powered on, the processor 211 first loads the continuity status table from the memory module 220 into the buffer memory 214. This enables the processor 211 to immediately learn the continuity status of each mapping table without re-evaluation. Then, when the system receives a data access operation corresponding to one of the first-state mapping tables, the processor 211 loads the corresponding contiguous segment mapping table from the memory module 220, rather than the complete mapping table. This on-demand loading mechanism reduces the initialization overhead during system startup, while ensuring that data access operations can take advantage of the contiguous segment mapping table.

For example, suppose there are 10 mapping tables in the storage device 20, of which 3 mapping tables have a continuity status of the first state. Prior to shutdown, the processor 211 stores the continuity status table and the contiguous segment mapping tables corresponding to those 3 mapping tables into the memory module 220. Upon the next startup, the processor 211 first loads the continuity status table, and then loads the corresponding contiguous segment mapping tables only when access to those 3 specific mapping tables is needed, while for the other 7 mapping tables, the complete mapping tables are loaded when needed.

In step S380, if the determination result is no (i.e., not entering the shutdown procedure), the processor 211 updates the contiguous segment mapping table according to subsequent data access commands. This ensures that the contiguous segment mapping table reflects the latest mapping relationships, maintaining data consistency.

When the target continuity status is the second state (right branch):

In step S340, the processor 211 builds the target mapping table in the buffer memory 214 based on the contiguous segment mapping table, and removes the contiguous segment mapping table. This step indicates that when the continuity status of the mapping table changes from the first state to the second state, the processor 211 needs to convert the contiguous segment mapping table back into the complete target mapping table, so as to accommodate changes in the physical address distribution.

In step S351, the processor 211 determines whether to enter a shutdown procedure.

In step S370, if the determination result is yes, the processor 211, in response to shutdown, stores the target mapping table and the corresponding target continuity status. Similar to step S360, this step ensures that the complete target mapping table and the latest continuity status table can be correctly saved when the system is powered off.

In step S390, if the determination result is no (i.e., not entering the shutdown procedure), the processor 211 updates the target mapping table according to subsequent data access commands. This ensures that the target mapping table can timely reflect changes in the mapping relationships.

Through this adaptive management mechanism, the storage device 20 is capable of intelligently selecting the most appropriate mapping table form according to actual usage conditions, so as to optimize resource utilization while improving performance, providing users with a more efficient storage experience.

In another embodiment, the processor 211 is configured to perform a mapping table optimization operation when the system is in an idle state. Specifically, the processor 211 selects, from the continuity status table, another target mapping table whose continuity status is the second state (i.e., relatively poor contiguity). Then, the processor 211 performs a garbage collection operation on a plurality of source physical blocks corresponding to the target mapping table, reorganizing and storing valid data from the source physical blocks into a plurality of other target physical blocks.

After the garbage collection operation, the processor 211 updates the mapping relationship between logical addresses and physical addresses in the target mapping table, and re-evaluates the continuity status of the mapping table. If, after garbage collection and reorganization, the continuity status of the target mapping table becomes the first state (i.e., contiguity improves), the processor 211 builds a corresponding contiguous segment mapping table and stores it into the memory module 220.

This proactive optimization mechanism allows the storage device 20 to improve the contiguity characteristics of mapping tables when the system is idle, thereby increasing opportunities to use contiguous segment mapping tables and further improving system performance and resource utilization efficiency. For example, assuming that a mapping table originally has a contiguous address coverage rate of 25% (the second state), after the garbage collection operation, data within the same logical address range is reorganized into contiguous physical addresses, raising the contiguous address coverage rate to 85% (the first state). Upon detecting this change, the processor 211 builds a contiguous segment mapping table for the mapping table, thereby providing a more efficient address mapping method for subsequent data access operations.

Through this dynamic optimization and state preservation mechanism, the storage device 20 is capable of continuously optimizing the management of mapping tables throughout the device lifecycle, adapting to changes in data distribution, and quickly recovering to an optimal state after device restart, thereby providing stable and efficient storage performance.

It should be noted that buffer memory resources are a valuable and limited resource during the operation of the storage device. When it is necessary to simultaneously process multiple mapping tables and contiguous segment mapping tables, efficient management of these resources becomes particularly important. The present disclosure provides two complementary buffer memory resource management mechanisms, capable of selecting the most appropriate management strategy according to the actual operating characteristics of the system, so as to optimize resource utilization while ensuring data access performance. These two mechanisms are based on access frequency statistics and the principle of temporal locality, respectively, and achieve dynamic allocation and eviction of buffer memory resources through intelligent selection of replacement targets, ensuring that the system can maintain efficient operation under limited resources.

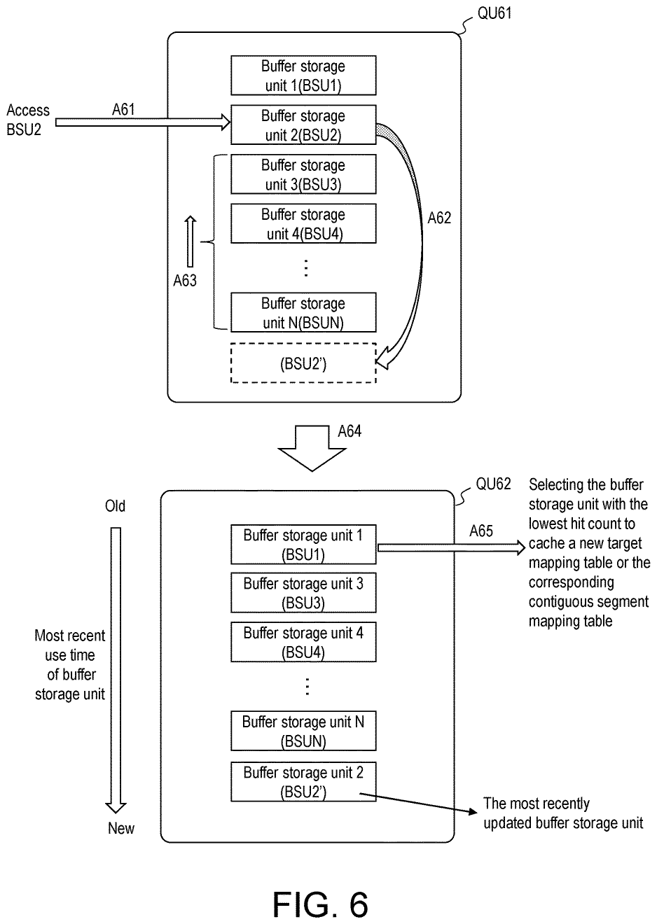

In an embodiment, the processor 211 is configured to monitor resource usage of the buffer memory 214, and execute a specific management mechanism to optimize usage of a plurality of buffer storage units in the buffer memory 214. Each buffer storage unit is configured to cache one or more mapping tables or one or more contiguous segment mapping tables. As shown in FIG. 5 and FIG. 6, the present embodiment provides two different buffer memory resource management mechanisms.

FIG. 5 is a schematic diagram illustrating buffer storage unit management based on hit count according to an embodiment of the present disclosure.

Referring to FIG. 5, in an embodiment, the processor 211 implements a buffer storage unit management mechanism based on hit count statistics. As shown in FIG. 5, the processor 211 maintains a hit count table TB5 for recording access frequency data of each buffer storage unit in the buffer memory 214.

In an embodiment, each buffer storage unit (e.g., BSU1, BSU2, BSU3) may be used to cache one or more mapping tables or one or more contiguous segment mapping tables. Specifically, when the processor 211 needs to access a mapping table or a contiguous segment mapping table, it first checks whether the mapping table already exists in a buffer storage unit of the buffer memory 214. If so, the mapping table is accessed directly; if not, the mapping table needs to be loaded from the memory module 220 into a buffer storage unit of the buffer memory 214.

The processor 211 continuously performs hit count statistics on the plurality of buffer storage units in the buffer memory 214. Each time the processor 211 accesses a mapping table or a contiguous segment mapping table in a buffer storage unit, the hit count counter value of that buffer storage unit increases. As shown in FIG. 5, the hit count of buffer storage unit BSU1 is 25, indicating that the mapping table stored in the unit is frequently accessed; the hit count of buffer storage unit BSU2 is 17, indicating a lower access frequency; while the hit count of buffer storage unit BSU3 is only 3, indicating that the mapping table stored therein is rarely accessed.

In an embodiment, when the available space of the buffer memory 214 is lower than the preset space threshold, the processor 211 needs to evict some buffer storage units to free up space for loading new mapping tables or contiguous segment mapping tables. Under the first management mechanism, the processor 211 selects a first target buffer storage unit having a hit count lower than a hit threshold for eviction. As shown in operation A51 of FIG. 5, the processor 211 selects the buffer storage unit BSU3 with the lowest hit count for eviction, moves the one or more mapping tables or one or more contiguous segment mapping tables stored in the buffer storage unit BSU3 to the memory module 220, and uses the freed space to cache a new target mapping table or a corresponding contiguous segment mapping table.

In a specific example, assuming the hit threshold is set to 10, when the buffer memory 214 has insufficient space, the processor 211 selects all buffer storage units with a hit count lower than 10 as eviction targets. In FIG. 5, only BSU3 has a hit count (3) lower than the threshold and is therefore selected as the eviction target. If multiple buffer storage units have hit counts lower than the hit threshold, the processor 211 may evict them in ascending order of hit count until sufficient space is freed.

The advantage of this management mechanism lies in its ability to retain hot data (i.e., frequently accessed mapping tables) in the buffer memory 214, while evicting space occupied by cold data (i.e., rarely accessed mapping tables). This access-frequency-based management strategy is particularly suitable for workloads with pronounced access hot spots, and is capable of effectively improving the cache hit rate and reducing the number of times the same mapping table is repeatedly loaded from the memory module 220, thereby improving system performance.

In an embodiment, prior to evicting a buffer storage unit, the processor 211 ensures data consistency of the mapping tables or contiguous segment mapping tables stored therein. If a mapping table in the buffer storage unit has been modified, the processor 211 writes it back to the memory module 220 before freeing the space of the buffer storage unit. For contiguous segment mapping tables corresponding to mapping tables whose continuity status is the first state, the processor 211 prioritizes retaining them in the buffer memory 214 when system resources permit, so as to improve the efficiency of subsequent accesses.

FIG. 6 is a schematic diagram illustrating buffer storage unit management based on queue management according to an embodiment of the present disclosure.

Referring to FIG. 6, in an embodiment, the processor 211 implements a buffer storage unit management mechanism based on the Least Recently Used (LRU) principle. As shown in FIG. 6, the processor 211 maintains a cache queue structure QU61 for managing a plurality of buffer storage units in the buffer memory 214.

In an embodiment, each buffer storage unit (e.g., BSU1, BSU2, BSU3) is configured to cache one or more mapping tables or one or more contiguous segment mapping tables. When the processor 211 needs to access a particular mapping table, it first checks whether the mapping table has already been cached in the buffer memory 214. If the mapping table has been cached, the processor 211 reads directly from the corresponding buffer storage unit; if not cached, the processor 211 loads the mapping table from the memory module 220 into a buffer storage unit in the buffer memory 214.

As shown by arrow A61, when the processor 211 accesses the mapping table in the buffer storage unit BSU2, an update operation of the cache queue structure is triggered. Specifically, the processor 211 removes the accessed buffer storage unit BSU2 from the queue QU61. As shown by arrow A62, the processor 211 then marks the buffer storage unit as BSU2′ and adds it to the tail of the queue QU61. As shown by arrow A63, the relative positions of other buffer storage units in the queue remain unchanged, and only the queue structure is adjusted to accommodate the movement of the buffer storage unit BSU2.

As shown by arrow A64, the queue QU61 transitions to queue QU62, wherein the head of the queue is now the buffer storage unit BSU1, while the most recently accessed buffer storage unit BSU2′ is located at the tail of the queue. The buffer storage units in the queue are arranged from oldest to most recent in terms of last-used time, and the vertical arrow on the left side indicates this chronological order. As shown on the right side of FIG. 6, the buffer storage unit BSU2′ at the tail of the cache queue is regarded by the processor 211 as the most recently updated buffer storage unit.

When the available space of the buffer memory 214 is lower than a preset space threshold, the processor 211 needs to evict some buffer storage units to free up space. As shown by arrow A65, if the second management mechanism is adopted, the processor 211 selects the buffer storage unit BSU1 from the head of the queue QU62 as the second target buffer storage unit for eviction. This is based on the LRU principle, which assumes that data that has not been accessed for the longest period of time has the lowest probability of being accessed again in the near future.

In actual operation, when the processor 211 needs to cache a new target mapping table or a corresponding contiguous segment mapping table, it first checks the available space of the buffer memory 214. If the available space is sufficient, the processor 211 directly allocates a new buffer storage unit; if the available space is insufficient (lower than the preset space threshold), the processor 211 selects the least recently accessed buffer storage unit BSU1 from the head of the queue QU62 for eviction. Prior to evicting the buffer storage unit BSU1, the processor 211 ensures that the mapping table data stored therein has been correctly written back to the memory module 220 (if necessary), and then releases the space of the buffer storage unit for storing the new mapping table.

This queue-based management mechanism leverages the temporal locality principle of data access, which holds that data accessed recently is likely to be accessed again in the near future. By retaining the most recently accessed buffer storage units at the tail of the queue and evicting buffer storage units at the head of the queue, the processor 211 can effectively improve the cache hit rate, reduce the number of times mapping tables are repeatedly loaded from the memory module 220, and thereby optimize system performance.

In an embodiment, for contiguous segment mapping tables corresponding to mapping tables whose continuity status is the first state, even if they are located near the head of the queue, the processor 211 takes into account their special nature and avoids designating them as eviction targets when possible, so as to maintain efficient utilization of contiguous segment mapping tables by the system. When a plurality of mapping tables are stored in the same buffer storage unit, the processor 211 moves the unit as a whole within the queue, ensuring the integrity of the relevant mapping table data. In another embodiment, the processor 211 traverses the cache queue from front to back to find the buffer storage unit having the greatest number of mapping tables in the second state for eviction.

In an embodiment, assume that the total capacity of the buffer memory 214 is 32 MB, with 24 MB initially allocated for complete mapping tables and 8 MB allocated for contiguous segment mapping tables. As the system operates, if the processor 211 finds that an increasing number of mapping tables exhibit good contiguity (the first state), more space may be reallocated to contiguous segment mapping tables, for example, adjusting to 20 MB for complete mapping tables and 12 MB for contiguous segment mapping tables. This dynamic adjustment ensures that the system can adapt to changes in data distribution characteristics and always maintain an optimal resource allocation ratio.

It is worth noting that when performing dynamic resource allocation, the processor 211 takes into account the current workload characteristics of the storage device 20. For example, in write-intensive workloads, data distribution may change frequently, and the processor 211 may adopt a more conservative allocation strategy to avoid rebuilding contiguous segment mapping tables too frequently; in read-intensive workloads, data distribution is relatively stable, and the processor 211 may more aggressively build and cache contiguous segment mapping tables to improve read performance.

The present embodiment further provides a computer program product comprising computer-readable code, or a non-volatile computer-readable storage medium bearing computer-readable code, wherein when the computer-readable code is executed in a processor, the processor performs the steps of the memory management method described above. The computer program product may be implemented specifically through hardware, firmware, software, or a combination thereof. In one optional embodiment, the computer program product is embodied as a computer storage medium; in another optional embodiment, the computer program product is embodied as a software product, such as a Software Development Kit (SDK).

Based on the foregoing, the memory management method and memory controller provided by the present disclosure achieve technical effects in multiple aspects. By introducing a continuity status table to record the continuity characteristics of mapping tables and selecting the most suitable mapping table processing method based thereon, good performance and resource utilization efficiency can be maintained under different data distribution characteristics. For mapping tables with good contiguity, using a contiguous segment mapping table can significantly save buffer memory space, while for mapping tables with poor contiguity, directly using the complete mapping table can avoid the overhead of unnecessary contiguity analysis.

The dynamic evaluation mechanism provided by the present disclosure is capable of analyzing the continuity characteristics of mapping tables in real time and accurately calculating the contiguous address coverage rate, thereby providing a reliable basis for selecting the mapping table processing method. At the same time, through the storage structure of the contiguous segment mapping table, which records only the key information of each contiguous segment (such as starting address and length), the access efficiency of the contiguous segment mapping table is improved and buffer memory space is saved.

In terms of buffer memory resource management, the two complementary management mechanisms provided by the present disclosure (based on hit count and based on queue structure) enable the system to select the most appropriate resource eviction strategy according to actual workload characteristics, maintaining efficient operation under resource-constrained conditions. The mapping table optimization operations performed when the system is idle improve the contiguity characteristics of mapping tables, increase the opportunities for utilizing contiguous segment mapping tables, and further enhance system performance.

The method of the present disclosure further specifically accounts for system shutdown and startup scenarios, and through differentiated storage strategies and on-demand loading mechanisms, reduces the initialization burden at system startup while ensuring data consistency.

Finally, it should be noted that the foregoing embodiments are merely intended to illustrate the technical solutions of the present invention and are not intended to limit the same. Although the present invention has been described in detail with reference to the foregoing embodiments, persons of ordinary skill in the art should understand that modifications may still be made to the technical solutions described in the foregoing embodiments, or equivalent substitutions may be made to some or all of the technical features thereof, and such modifications or substitutions do not cause the essence of the corresponding technical solutions to depart from the scope of the technical solutions of the embodiments of the present invention.

What is claimed is:

1. A memory management method, applied to a storage device configured with a memory module, the method comprising:
obtaining a continuity status table, the continuity status table configured to characterize a continuity status of physical address arrangements in at least one mapping table;
according to a data access command and the continuity status table, identifying a target mapping table corresponding to the data access command, and obtaining a target continuity status of the target mapping table; and
determining an execution strategy for the data access command according to the target continuity status, so as to complete an access operation of target data.

2. The memory management method as claimed in claim 1, wherein the method of determining the execution strategy for the data access command according to the target continuity status comprises:
determining, according to the target continuity status, whether to use a contiguous segment mapping table corresponding to the target mapping table;
if it is determined to use the contiguous segment mapping table, loading the contiguous segment mapping table into a buffer memory of the storage device; and
obtaining a physical address corresponding to the data access command according to the contiguous segment mapping table, so as to complete the access operation of the target data.

3. The memory management method as claimed in claim 2, further comprising:
if it is determined not to use the contiguous segment mapping table, loading the target mapping table into the buffer memory, wherein the continuity status of the physical address arrangement in each of the mapping tables is one of a first state, a second state, and a third state, and the contiguous segment mapping table corresponding to the target mapping table comprises a plurality of contiguous segment information, each contiguous segment information comprising at least a plurality of contiguous logical addresses and a plurality of contiguous physical addresses; and
obtaining a physical address corresponding to the data access command according to the target mapping table, so as to complete the access operation of the target data.

4. The memory management method as claimed in claim 1, wherein prior to the obtaining the continuity status table, the method further comprises:
maintaining the continuity status table, wherein:
when updating the at least one mapping table, analyzing distribution characteristics of a plurality of physical addresses involved, so as to calculate a corresponding update physical address contiguity coverage rate;
when the update physical address contiguity coverage rate is higher than a first preset coverage rate threshold, determining that the continuity status of the mapping table is a first state;
when the update physical address contiguity coverage rate is lower than a second preset coverage rate threshold, determining that the continuity status of the mapping table is a second state; and
when a quantity of physical addresses involved in the update is lower than a preset quantity threshold, or the update physical address contiguity coverage rate is between the first preset coverage rate threshold and the second preset coverage rate threshold, determining that the continuity status of the mapping table is a third state.

5. The memory management method as claimed in claim 2, wherein the determining, according to the target continuity status, whether to use the contiguous segment mapping table corresponding to the target mapping table comprises:
if the target continuity status is the first state, determining to use the contiguous segment mapping table, wherein the contiguous segment mapping table has been pre-built when the system is idle;
if the target continuity status is the second state, determining not to use the contiguous segment mapping table; and
if the target continuity status is the third state, determining to use the contiguous segment mapping table, wherein the contiguous segment mapping table is built when processing the data access command.

6. The memory management method as claimed in claim 5, wherein the building the contiguous segment mapping table comprises:
analyzing all physical addresses in the target mapping table, and calculating a segment count and a full-table physical address contiguity coverage rate of the built contiguous segment mapping table;
if the segment count is less than a preset segment count threshold and the full-table physical address contiguity coverage rate is higher than a third preset coverage rate threshold, determining that the building is successful, loading the contiguous segment mapping table into the buffer memory, and updating the target continuity status to the first state; and
if the segment count is not less than the preset segment count threshold or the full-table physical address contiguity coverage rate is not higher than the third preset coverage rate threshold, determining that the building has failed, loading the target mapping table into the buffer memory, and updating the target continuity status to the second state.

7. The memory management method as claimed in claim 6, wherein the update physical address contiguity coverage rate and the full-table physical address contiguity coverage rate are calculated using the same calculation method, comprising:
analyzing address differences between adjacent physical addresses in a target physical address sequence to be evaluated;
identifying one or more contiguous physical address subsequences having a fixed preset difference, and dividing them into a plurality of contiguous segments;
calculating a sum of quantities of physical addresses contained in all of the contiguous segments; and
dividing the sum of the quantities of physical addresses by a total address quantity of the target physical address sequence, so as to obtain a corresponding contiguous address coverage rate.

8. The memory management method as claimed in claim 1, further comprising:
monitoring resource usage of a buffer memory of the storage device;
executing a first management mechanism or a second management mechanism, configured to manage usage of a plurality of buffer storage units in the buffer memory, each buffer storage unit configured to cache one or more mapping tables or one or more contiguous segment mapping tables,
wherein the first management mechanism comprises continuously performing hit count statistics on the plurality of buffer storage units in the buffer memory,
wherein the second management mechanism comprises maintaining a cache queue structure for managing the plurality of buffer storage units in the buffer memory, and moving a particular accessed buffer storage unit to a tail of the queue;
when available space of the buffer memory is lower than a preset space threshold:
if the first management mechanism is adopted, selecting a first target buffer storage unit having a hit count lower than a hit threshold for eviction; and
if the second management mechanism is adopted, selecting a second target buffer storage unit from a head of the queue for eviction.

9. The memory management method as claimed in claim 3, wherein the contiguous segment information is stored in one of the following forms:
a first form, comprising:
a starting logical address, indicating a first logical address in the contiguous segment;
a starting physical address, indicating a physical address corresponding to the starting logical address; and
a segment length, indicating a quantity of consecutive addresses in the contiguous segment; and
a second form, comprising:
a starting logical address and an ending logical address, indicating a first logical address and a last logical address in the contiguous segment, respectively; and
a starting physical address and an ending physical address, indicating physical addresses corresponding to the starting logical address and the ending logical address, respectively.

10. The memory management method as claimed in claim 4, further comprising:
prior to the storage device being powered off, storing the continuity status table into the memory module;
for one or more mapping tables whose continuity status in the continuity status table is the first state, storing one or more contiguous segment mapping tables corresponding to the one or more mapping tables into the memory module;
upon the storage device being powered on, loading the continuity status table from the memory module into the buffer memory; and
in response to a data access operation corresponding to one of the one or more mapping tables, loading a corresponding contiguous segment mapping table from the memory module.

11. The memory management method as claimed in claim 3, further comprising:
when the system is in an idle state, selecting, from the continuity status table, another target mapping table whose continuity status is the second state;
performing a garbage collection operation on a plurality of source physical blocks corresponding to the other target mapping table, so as to store valid data corresponding to the plurality of source physical blocks into a plurality of other target physical blocks;
updating a mapping relationship between logical addresses and physical addresses in the other target mapping table, so as to obtain the continuity status of the other target mapping table; and
if the continuity status of the other target mapping table is the first state, building and storing the contiguous segment mapping table corresponding to the other target mapping table into the memory module.

12. A memory controller for controlling a storage device configured with a memory module, the memory controller comprising:
a memory interface control circuit configured to be electrically connected to the memory module; and
a processor electrically connected to the memory interface control circuit, wherein the processor is further electrically connected to a connection interface circuit of the storage device so as to be electrically connected to a host system,
wherein the processor is configured to:
obtain a continuity status table, the continuity status table configured to characterize a continuity status of physical address arrangements in at least one mapping table;
according to a data access command and the continuity status table, identify a target mapping table corresponding to the data access command, and obtain a target continuity status of the target mapping table; and
determine an execution strategy for the data access command according to the target continuity status, so as to complete an access operation of target data.

13. The memory controller as claimed in claim 12, wherein in the operation of determining the execution strategy for the data access command according to the target continuity status:
the processor determines, according to the target continuity status, whether to use a contiguous segment mapping table corresponding to the target mapping table;
if it is determined to use the contiguous segment mapping table, the processor loads the contiguous segment mapping table into a buffer memory of the storage device; and
the processor obtains a physical address corresponding to the data access command according to the contiguous segment mapping table, so as to complete the access operation of the target data.

14. The memory controller as claimed in claim 13, wherein the processor is further configured to:
if it is determined not to use the contiguous segment mapping table, load the target mapping table into the buffer memory, wherein the continuity status of the physical address arrangement in each of the mapping tables is one of a first state, a second state, and a third state; and the contiguous segment mapping table corresponding to the target mapping table comprises a plurality of contiguous segment information, each contiguous segment information comprising at least a plurality of contiguous logical addresses and a plurality of contiguous physical addresses; and
obtain a physical address corresponding to the data access command according to the target mapping table, so as to complete the access operation of the target data.

15. The memory controller as claimed in claim 13, wherein prior to obtaining the continuity status table, the processor is further configured to:
maintain the continuity status table, wherein:
when updating the at least one mapping table, analyzing distribution characteristics of a plurality of physical addresses involved, so as to calculate a corresponding update physical address contiguity coverage rate;
when the update physical address contiguity coverage rate is higher than a first preset coverage rate threshold, determining that the continuity status of the mapping table is a first state;
when the update physical address contiguity coverage rate is lower than a second preset coverage rate threshold, determining that the continuity status of the mapping table is a second state; and
when a quantity of physical addresses involved in the update is lower than a preset quantity threshold, or the update physical address contiguity coverage rate is between the first preset coverage rate threshold and the second preset coverage rate threshold, determining that the continuity status of the mapping table is a third state.

16. The memory controller as claimed in claim 12, wherein the determining, according to the target continuity status, whether to use the contiguous segment mapping table corresponding to the target mapping table comprises:
if the target continuity status is the first state, determining to use the contiguous segment mapping table, wherein the contiguous segment mapping table has been pre-built when the system is idle;
if the target continuity status is the second state, determining not to use the contiguous segment mapping table; and
if the target continuity status is the third state, determining to use the contiguous segment mapping table, wherein the contiguous segment mapping table is built when processing the data access command.

17. The memory controller as claimed in claim 16, wherein the building the contiguous segment mapping table comprises:
analyzing all physical addresses in the target mapping table, and calculating a segment count and a full-table physical address contiguity coverage rate of the built contiguous segment mapping table;
if the segment count is less than a preset segment count threshold and the full-table physical address contiguity coverage rate is higher than a third preset coverage rate threshold, determining that the building is successful, loading the contiguous segment mapping table into the buffer memory, and updating the target continuity status to the first state; and
if the segment count is not less than the preset segment count threshold or the full-table physical address contiguity coverage rate is not higher than the third preset coverage rate threshold, determining that the building has failed, loading the target mapping table into the buffer memory, and updating the target continuity status to the second state.

18. The memory controller as claimed in claim 17, wherein the update physical address contiguity coverage rate and the full-table physical address contiguity coverage rate are calculated using the same calculation method, comprising:
analyzing address differences between adjacent physical addresses in a target physical address sequence to be evaluated;
identifying one or more contiguous physical address subsequences having a fixed preset difference, and dividing them into a plurality of contiguous segments;
calculating a sum of quantities of physical addresses contained in all of the contiguous segments; and
dividing the sum of the quantities of physical addresses by a total address quantity of the target physical address sequence, so as to obtain a corresponding contiguous address coverage rate.

19. The memory controller as claimed in claim 12, wherein the processor is further configured to:
monitor resource usage of a buffer memory of the storage device;
execute a first management mechanism or a second management mechanism, configured to manage usage of a plurality of buffer storage units in the buffer memory, each buffer storage unit configured to cache one or more mapping tables or one or more contiguous segment mapping tables,
wherein the first management mechanism comprises continuously performing hit count statistics on the plurality of buffer storage units in the buffer memory,
wherein the second management mechanism comprises maintaining a cache queue structure for managing the plurality of buffer storage units in the buffer memory, and moving a particular accessed buffer storage unit to a tail of the queue;
when available space of the buffer memory is lower than a preset space threshold:
if the first management mechanism is adopted, select a first target buffer storage unit having a hit count lower than a hit threshold for eviction; and
if the second management mechanism is adopted, select a second target buffer storage unit from a head of the queue for eviction.

20. The memory controller as claimed in claim 14, wherein the contiguous segment information is stored in one of the following forms:
a first form, comprising:
a starting logical address, indicating a first logical address in the contiguous segment;
a starting physical address, indicating a physical address corresponding to the starting logical address; and
a segment length, indicating a quantity of consecutive addresses in the contiguous segment; and
a second form, comprising:
a starting logical address and an ending logical address, indicating a first logical address and a last logical address in the contiguous segment, respectively; and
a starting physical address and an ending physical address, indicating physical addresses corresponding to the starting logical address and the ending logical address, respectively.
